(19) United States
(12) Patent Application Publication
(10) Pub. No.: US 2024/0011906 A1
(43) Pub. Date: Jan. 11, 2024

(54) EUROPIUM DOPED METAL-ORGANIC FRAMEWORK FOR DETECTION OF HETEROAROMATIC COMPOUNDS

(71) Applicant: KING FAHD UNIVERSITY OF PETROLEUM AND MINERALS, Dhahran (SA)

(72) Inventors: Aasif HELAL, Dhahran (SA); Mohammad Mizanur RAHMAN, Dhahran (SA); Muhammed NAEEM, Dhahran (SA); Md. Eyasin ARAFAT, Dhahran (SA); Muhammad USMAN, Dhahran (SA)

(73) Assignee: KING FAHD UNIVERSITY OF PETROLEUM AND MINERALS, Dhahran (SA)

(21) Appl. No.: 17/857,545

(22) Filed: Jul. 5, 2022

(51) Int. Cl. G01N 21/64; C09K 11/06; C07F 15/04

(52) U.S. Cl. CPC G01N 21/6428; C09K 11/06; C07F 15/045; C09K 2211/187; C09K 2211/182

(57) ABSTRACT

An europium doped Ni(BTC) Metal Organic Framework (MOF), Eu@Ni(BTC), as a sensor for detecting heteroaromatic compounds. Eu@Ni(BTC) shows selectivity towards thiophene and pyrrole with a detection limit of 0.2 and 8.4 ppm for thiophene and pyrrole, respectively. The sensor can be easily regenerated and can be used to analyze thiophene in water.

### STATEMENT OF PRIOR DISCLOSURE BY THE INVENTOR

Aspects of the present disclosure are described in A. Helal; “Europium doped Ni(BTC) metal-organic framework for detection of heteroaromatic compounds in mixed aqueous media”; Oct. 20, 2021; Materials Research Bulletin, incorporated herein by reference in its entirety.

### BACKGROUND

### Technical Field

This invention relates to metal doped metal organic frameworks (MOFs), especially europium doped metal organic frameworks, an optical sensor that contains the metal doped metal organic frameworks, a method of making the metal doped metal organic frameworks, and a method for detecting organic compounds using the metal doped metal organic frameworks.

### Description of the Related Art

Drinking water that originates from groundwater reservoirs contains a considerable amount of aromatic and heteroaromatic (nitrogen, sulfur and oxygen containing) compounds. These heteroaromatic compounds have their anthropogenic origin in oil, pharmaceuticals, chemicals, and creosote as disclosed by Johansen et al. in Johansen, S. S.; Arvin, E.; Mosbaek, H.; Hansen, A. B.; Toxicol. Environ. Chem. 1998, 66, 195-228. Many heteroaromatic compounds such as thiophene, dibenzothiophene, benzofuran, carbazole, indole, pyrrole, pyridines, and quinolones are found in the groundwater near wood preserving factories and gas works. Besides being highly toxic, these materials add bad taste and smell to the groundwater. These heteroaromatic compounds have mutagenic, carcinogenic, teratogenic effects and have adverse organoleptic characteristics also as disclosed by Kodamatani et al. in Kodamatani, H.; Komatsu, Y.; Yamazaki S, Saito, K. Anal. Sci. 1996, 23, 407-4011. Various techniques are available for the detection of these heteroaromatic compounds in groundwater such as high performance liquid chromatography (HPLC) with ultraviolet (UV) detection, gas chromatography-mass spectrometry (GC-MS), and liquid chromatography-mass spectrometry (LC-MS) as disclosed by Khullar et al. in Khullar, S.; Singh, S.; Das, P.; Mandal, S. K. ACS Omega 2019, 4, 5283-5292. These methods involve intensive sample preparation, which is laborious, time consuming, have a high risk of contamination and sample loss. Moreover, the instrumental analysis involves expensive and complex instruments with well-established infrastructures. Hence, there is a need for a simple, affordable, highly selective, and sensitive analytical method which can detect these contaminants easily with high resolution.

In recent decades, metal-organic frameworks (MOFs) have become a significant material for chemists and material engineers due to their crystalline nature, high porosity, tunable pores, and moderately high stability as described by Hu et al. in Hu, M. L.; Razavi, S. A. A.; Piroozzadeh, M.; Morsali, A. Inorg. Chem. Front. 2020, 7, 1598-1632. MOFs have been extensively used in gas adsorption and separation as disclosed by He et al. in He, Y.; Zhou, W.; Qian, G.; Chen, B. Chem. Soc. Rev.2014, 43, 5657-5678; catalysis as disclosed by Corma et al. in Corma, A.; García, H.; Llabrés, F.; Xamen, X. Chem. Rev. 2010, 110, 4606-4655; electrochemical applications as disclosed by Topcu in Topçu, E. Mater. Res. Bull. 2020, 121, 110629; and sensing as disclosed by Moghzi et al. in Moghzi, F.; Soleimannejad, J.; Sañudo, E. C.; Janczak, J. Mater. Res. Bull. 2020, 122, 110683. Luminescent MOFs act as efficient fluorescent chemosensors because of their large surface area and open channels which permit fast diffusion, while efficiently functionalized pores cater interactional sites for the detection of specific analytes as disclosed by Zhao et al. in Zhao, Y.; Yang, X. G.; Lu, X. M.; Yang, C. D.; Fan, N. N.; Yang, Z. T.; Wang, L.Y.; Ma. L. F. Inorg. Chem. 2019, 58, 6215-6221; and Zhao, Y.; Wang, L.; Fan, N. N.; Han, M. L.; Yang, G. P.; Ma, L. F. Cryst. Growth Des. 2018, 18, 7114-7121.

Nickel-based MOFs have been broadly used in different applications due to the low cost and natural abundance of nickel. The common applications of these nickel-based MOFs are in the development of electrode materials as disclosed by Yuan et al. in Yuan, M.; Wang, R.; Sun, Z.; Lin, L.; Yang, H.; Li, H.; Nan, C.; Sun, G.; Ma, S. Inorg. Chem. 2019, 58, 11449-11457; hydrogen adsorption as disclosed by Pham et al. in Pham, T.; Forrest, K. A.; Banerjee, R.; Orcajo, G.; Eckert, J.; Space, B. J. Phys. Chem. C 2015, 119, 1078-1090; supercapacitors as disclosed by Zhang et al. in Zhang, J.; Li, Y.; Han, M.; Xia, Q.; Chen, Q.; Chen, M. Mater. Res. Bull. 2021, 137, 111186; energy storage devices as disclosed by Mofokeng et al. in Mofokeng, T. P.; Ipadeola, A. K.; Tetana, Z. N.; Ozoemena, K. I. ACS Omega 2020, 5, 20461-20472; and luminescent sensors for the detection of ions and neutral molecules as disclosed by Liu et al. in Liu, Y.; Lu, Y.-K.; Zhang, B.; Hou, L.; Wang, Y.-Y. Inorg. Chem. 2020, 59, 7531-7538. Ni(BTC) (BTC=1,3,5-benzene tricarboxylic acid) based MOFs have been used in chemical catalysis as disclosed by Arrozi et al. in Arrozi, U. S. F.; Bon, V.; Kutzscher, C.; Senkovska, I.; Kaskel, S. Dalton Trans., 2019, 48, 3415-3421. But the application of this MOF as an optical sensor is limited due to its very low emission property. In order to make it optically active, the linker or the secondary building unit (SBU) must be functionalized with a fluorogenic moiety.

Accordingly, one object of the invention is to provide metal doped metal organic frameworks (MOFs), especially europium doped metal organic frameworks, an optical sensor that contains the metal doped metal organic frameworks, a method of making the metal doped metal organic frameworks, and a method for detecting organic compounds using the metal doped metal organic frameworks.

### SUMMARY

In an exemplary embodiment, an europium doped metal-organic framework for detecting heteroaromatic compounds is disclosed. The europium doped metal-organic framework comprises europium and Ni-BTC. The europium is doped in the Ni-BTC. The europium doped metal-organic framework has a formula of Ni₃(BTC)₂·12H₂O:x % Eu³⁺ wherein x is in a range of 1 to 12.

In some embodiments, the europium doped metal-organic framework has a surface area of 250 to 450 square meter per gram (m²/g).

In some embodiments, the europium doped metal-organic framework has sheets clustered into round flower-shaped structures.

In some embodiments, the europium doped metal-organic framework has a weight loss of less than 10% when heated to a temperature of up to 300° C. for at least 15 minutes.

In some embodiments, the europium doped metal-organic framework has a maximum of 10% europium doping to retain the connectivity and framework.

In some embodiments, a method for producing the europium doped metal-organic framework for detecting heteroaromatic compounds is disclosed. The method includes mixing nickel nitrate, europium nitrate, and trimesic acid to produce a mixture, heating the mixture at 120 to 160° C. for 18 to 30 hours to produce a heated mixture, cooling the heated mixture to form a precipitate, and drying the precipitate to produce the europium doped metal-organic framework.

In some embodiments, the method includes mixing the europium doped metal-organic framework in an aqueous alcohol comprising an analyte to form a mixture and measuring a change in a fluorescence spectrum of the mixture. The analyte is at least one selected from a group comprising of S-Heterocycle, N-Heterocycle, and O-Heterocycle.

In some embodiments, the aqueous alcohol is 1 to 10% of alcohol in water.

In some embodiments, the concentration of analyte is 10⁻¹-10⁻³ M.

In some embodiments, the S-Heterocycle is at least one selected from a group comprising of thiophene, benzothiophene, dibenzothiophene, and dibenzothiophene sulfone.

In some embodiments, the N-Heterocycle is at least one selected from a group comprising of pyrrole, 1-methyl-pyrrole, indole, carbazole, pyridine, 2-methyl-pyridine, quinoline, 2-methyl-quinoline, 2-hydroxy quinoline, and acridine.

In some embodiments, the 0-Heterocycle is at least one selected from a group comprising of dibenzofuran, alkylated dibenzofuran, and furan.

In some embodiments, the analyte is thiophene or an alkylated thiophene with a detection limit of 0.1-0.5 ppm.

In some embodiments, the analyte is pyrrole or an alkylated pyrrole with a detection limit of 4-15 ppm.

In some embodiments, the method includes adding a polar solvent to the mixture, sonicating, and filtering to separate recovered europium doped metal-organic framework, and washing the recovered europium doped metal-organic framework with an ethanol solvent and drying at a temperature of 80-130° C. for at least 2 hours to separate recycled europium doped metal-organic framework.

In some embodiments, the europium doped metal-organic framework maintains detection activity after it is recycled up to 9 times.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a schematic representation of Eu@Ni(BTC), according to certain embodiments.

FIG. 2 shows powder X-ray diffraction (PXRD) analysis of Eu@Ni(BTC). The simulated pattern (bottom) of Ni(BTC) matches well with as-synthesized sample of Ni(BTC) (second from bottom), the 10% Europium doped sample Eu@Ni(BTC) (third from bottom) and Eu@Ni(BTC) after addition of Thiophene (top), according to certain embodiments.

FIG. 3 shows N₂ adsorption isotherms of Ni(BTC) and Eu@Ni(BTC). The filled and open circles represent the adsorption and desorption branches, respectively, according to certain embodiments.

FIG. 4A shows X-ray Photoelectron Spectroscopy (XPS) spectrum of Eu@Ni(BTC), according to certain embodiments.

FIG. 4B shows high-resolution XPS scan of the Eu 3d, according to certain embodiments.

FIG. 5 shows Thermogravimetric Analysis (TGA) of Eu@Ni(BTC), according to certain embodiments.

FIG. 6 shows chemical structures of heteroaromatic compounds investigated in this study, according to certain embodiments.

FIG. 7 shows change in the normalized absorbance of Eu@Ni(BTC) at 385 nm in 5% aqueous ethanol upon addition of 200 μL of different heteroaromatic compounds (10⁻² M), according to certain embodiments.

FIG. 8 shows changes in fluorescence spectra of Eu@Ni(BTC) upon addition of 200 μL of thiophene (10⁻² M) in 5% aqueous ethanol (═ₑₓ=327 nm). Inset: Fluorogenic change from red Eu@Ni(BTC) to colorless (Eu@Ni(BTC)-thiophene) upon addition of thiophene upon irradiation at 365 nm, according to certain embodiments.

FIG. 9 shows change in the normalized fluorescence emission of Eu@Ni(BTC) in 5% aqueous ethanol solution upon addition of 200 μL of different heteroaromatic compounds (10⁻² M; λₑₓ=327 nm), according to certain embodiments.

FIG. 10 shows changes in the emission spectrum of Eu@Ni(BTC) in 5% aqueous ethanol solution upon incremental addition of thiophene (λₑₓ=327 nm), according to certain embodiments.

FIG. 11 shows fluorescence intensity after regeneration of Eu@Ni(BTC) from Eu@Ni(BTC)+Thiophene for 5 cycles, according to certain embodiments.

FIG. 12 shows Powder X-ray Diffraction (PXRD) spectrum of Ni(BTC) with different ratio of Eu(III) (0-12%) doping, according to certain embodiments.

FIG. 13 shows Fourier Transform Infra-red (FTIR) spectra of Eu@Ni(BTC), according to certain embodiments.

FIG. 14 shows Scanning Electron Micrograph (SEM) image of Eu@Ni(BTC), according to certain embodiments.

FIG. 15 shows Energy Dispersive X-Ray Spectroscopy (EDS) analysis of Eu@Ni(BTC), according to certain embodiments.

FIG. 16 shows elemental mapping images of Eu@Ni(BTC), according to certain embodiments.

FIG. 17 shows changes in UV-vis spectra of Eu@Ni(BTC) with the incremental addition of Thiophene (10⁻² M) in 5% aqueous ethanol, according to certain embodiments.

FIG. 18 shows chromaticity diagram of Eu@Ni(BTC) (λₑₓ=327nm) in 5% aqueous ethanol, according to certain embodiments.

FIG. 19 shows changes in emission spectra of Eu@Ni(BTC) upon addition of 200 μL of different heteroaromatic compounds (10⁻² M) in water. (λₑₓ=327 nm) 5% aqueous ethanol, according to certain embodiments.

FIG. 20 shows fluorescence titration of Eu@Ni(BTC) with pyrrole in 5% aqueous ethanol, according to certain embodiments.

FIG. 21 shows Stern-Volmer plot of Eu@Ni(BTC) quenched by thiophene in 5% aqueous ethanol, according to certain embodiments. FIG. 22 shows Stern-Volmer plot of Eu@Ni(BTC) quenched by pyrrole in 5% aqueous ethanol, according to certain embodiments.

FIG. 23 shows competitive heteroaromatic compound selectivity of Eu@Ni(BTC): Bars indicate the fluorescence intensity (λₑₓ=327 nm, λₑₘ=615 nm). Various heteroaromatic compound (10⁻² mM) were added to Eu@Ni(BTC) and thiophene (10⁻² M), according to certain embodiments.

FIG. 24 shows linear region of fluorescence intensity (λₑₓ=327 nm and λₑₘ=615 nm) for Eu@Ni(BTC) suspensions in 5% aqueous ethanol upon incremental addition of thiophene solutions, according to certain embodiments.

FIG. 25 shows PXRD of Eu@Ni(BTC) after each cycle, according to certain embodiments.

FIG. 26 shows linear region of fluorescence intensity (λₑₓ=327 nm and λₑₘ=615 nm) for Eu@Ni(BTC) suspensions in 5% aqueous ethanol solution upon incremental addition of pyrrole solutions, according to certain embodiments.

### DETAILED DESCRIPTION

The present disclosure will be better understood with reference to the following definitions.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

In the drawings, like reference numerals designate identical or corresponding parts throughout the several views. Further, as used herein, the words “a,” “an” and the like generally carry a meaning of “one or more,” unless stated otherwise. Also, the use of “or” means “and/or” unless stated otherwise. Similarly, “comprise,” “comprises,” “comprising” “include,” “includes,” and “including” are interchangeable and not intended to be limiting.

Furthermore, the terms “approximately,” “approximate,” “about,” and similar terms generally refer to ranges that include the identified value within a margin of 20%, 10%, or preferably 5%, and any values there between. For example, if a stated value is about 8.0, the value may vary in the range of 8±1.6, ±1.0, ±0.8, ±0.5, ±0.4, ±0.3, ±0.2, or ±0.1.

Disclosure of values and ranges of values for specific parameters (such as temperatures, molecular weights, weight percentages, etc.) are not exclusive of other values and ranges of values useful herein. It is envisioned that two or more specific exemplified values for a given parameter may define endpoints for a range of values that may be claimed for the parameter.

For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10 it also describes subranges for Parameter X including 1-9, 1-8, 1-7, 2-9, 2-8, 2-7, 3-9, 3-8, 3-7, 2-8, 3-7, 4-6, or 7-10, 8-10 or 9-10 as mere examples. A range encompasses its endpoints as well as values inside of an endpoint, for example, the range 0-5 includes 0, >0, 1, 2, 3, 4, <5 and 5.

As used herein, the words “preferred” and “preferably” refer to embodiments of the technology that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology.

As used herein, the terms “optional” or “optionally” means that the subsequently described event(s) can or cannot occur or the subsequently described component(s) may or may not be present (e.g., 0 wt. %).

The term “alkyl”, as used herein, unless otherwise specified, refers to a straight, branched, or cyclic, saturated aliphatic fragment having 1 to 26 carbon atoms, (e.g., C₁, C₂, C₃, C₄, C₅, C₆, C₇, C₈, C₉, C₁₀, C₁₁, etc.) and specifically includes, but is not limited to, methyl, ethyl, propyl, isopropyl, butyl, isobutyl, t-butyl, pentyl, isopentyl, neopentyl, hexyl, isohexyl, 3-methylpentyl, 2,2-dimethylbutyl, 2,3-dimethylbutyl, 2-ethylhexyl, heptyl, octyl, nonyl, 3,7-dimethyloctyl, decyl, undecyl, dodecyl, tridecyl, tetradecyl, pentadecyl, hexadecyl, heptadecyl, octadecyl, nonadecyl, eicosyl, guerbet-type alkyl groups (e.g., 2-methylpentyl, 2-ethylhexyl, 2-propylheptyl, 2-butyloctyl, 2-pentylnonyl, 2-hexyldecyl, 2-heptylundecyl, 2-octyldodecyl, 2-nonyltridecyl, 2-decyltetradecyl, and 2-undecylpentadecyl), as well as cyclic alkyl groups (cycloalkyls) such as cyclopropyl, cyclobutyl, cyclopentyl, cyclohexyl, norbornyl, and adamantyl.

The term “aryl” means a carbocyclic aromatic monocyclic group containing 6 carbon atoms which may be further fused to a second 5- or 6-membered carbocyclic group which may be aromatic, saturated or unsaturated. Aryl includes, but is not limited to, phenyl, anthracenyl, indanyl, 1-naphthyl, 2-naphthyl, and tetrahydronaphthyl. The fused aryls may be connected to another group either at a suitable position on the cycloalkyl/cycloalkenyl ring or the aromatic ring.

The term “arylalkyl”, as used herein, refers to a straight or branched chain alkyl moiety (as defined above) that is substituted by an aryl group (as defined above), examples of which include, but are not limited to, benzyl, phenethyl, 2-methylbenzyl, 3-methylbenzyl, 4-methylbenzyl, 2,4-dimethylbenzyl, 2-(4-ethylphenyl)ethyl, 3-(3-propylphenyl)propyl, and the like.

The term “allyloxy”, as used herein, unless otherwise specified, refers to an —O—CH₂—CH═CH₂ group. Exemplary allyoxys that maybe used include (allyloxy)benzene, 3-methyl-allyloxybenzene, 1-allyloxy-2-chloromethylbenzene, 1-(allyloxy)-2-bromobenzene, etc.

As used herein, the term “substituted” refers to at least one hydrogen atom that is replaced with a non-hydrogen group, provided that normal valencies are maintained and that the substitution results in a stable compound. When a substituent is noted as “optionally substituted”, the substituent(s) are selected from alkyl, halo (e.g., chloro, bromo, iodo, fluoro), hydroxyl, alkoxy, oxo, alkanoyl, aryloxy, alkanoyloxy, amino (—NH₂), alkylamino (—NHalkyl), cycloalkylamino (—NHcycloalkyl), arylamino (—NHaryl), arylalkylamino (—NHarylalkyl), disubstituted amino (e.g., in which the two amino substituents are selected from alkyl, aryl or arylalkyl, including substituted variants thereof, with specific mention being made to dimethylamino), alkanoylamino, aroylamino, arylalkanoylamino, thiol, alkylthio, arylthio, arylalkylthio, alkylthiono, arylthiono, arylalkylthiono, alkylsulfonyl, arylsulfonyl, arylalkylsulfonyl, sulfonamide (e.g., —SO2NH2), substituted sulfonamide (e.g., —SO₂NHalkyl, —SO₂NHaryl, —SO₂NHarylalkyl, or cases where there are two substituents on one nitrogen selected from alkyl, aryl, or alkylalkyl), nitro, cyano, carboxy, unsubstituted amide (i.e. —CONH₂), substituted amide (e.g., —CONHalkyl, —CONHaryl, —CONHarylalkyl or cases where there are two substituents on one nitrogen selected from alkyl, aryl, or alkylalkyl), alkoxycarbonyl, aryl, guanidine, heterocyclyl (e.g., pyridyl, furyl, morpholinyl, pyrrolidinyl, piperazinyl, indolyl, imidazolyl, thienyl, thiazolyl, pyrrolidyl, pyrimidyl, piperidinyl, homopiperazinyl), and mixtures thereof. The substituents may themselves be optionally substituted, and may be either unprotected, or protected as necessary, as known to those skilled in the art.

As referred to herein, all compositional percentages are by weight of the total composition, unless otherwise specified. As used herein, the word “include,” and its variants, is intended to be non-limiting, such that recitation of items in a list is not to the exclusion of other like items that may also be useful in the materials, compositions, devices, and methods of this technology.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested.

Throughout the specification and the appended claims, a given chemical formula or name shall encompass all isomers (stereo and optical isomers and racemates) thereof where such isomers exist. Unless otherwise indicated, all chiral (enantiomeric and diastereomeric) and racemic forms are within the scope of the disclosure. Many geometric isomers of C═C double bonds, C═N double bonds, ring systems, and the like can also be present in the compounds, and all such stable isomers are contemplated in the present disclosure. Cis- and trans- (or E- and Z-) geometric isomers of the compounds of the present disclosure are described and may be isolated as a mixture of isomers or as separated isomeric forms. The present compounds can be isolated in optically active or racemic forms. Optically active forms may be prepared by resolution of racemic forms or by synthesis from optically active starting materials. All processes used to prepare compounds of the present disclosure and intermediates made therein are considered to be part of the present disclosure. When enantiomeric or diastereomeric products are prepared, they may be separated by conventional methods, for example, by chromatography, fractional crystallization, or through the use of a chiral agent. Depending on the process conditions the end products of the present disclosure are obtained either in free (neutral) or salt form. Both the free form and salts of products are within the scope of the disclosure. If so desired, one form of a compound may be converted into another form. A free base or acid may be converted into a salt; a salt may be converted into the free compound or another salt; a mixture of isomeric compounds of the present disclosure may be separated into the individual isomers. Compounds of the present disclosure, free form and salts thereof, may exist in multiple tautomeric forms, in which hydrogen atoms are transposed to other parts of the molecules and the chemical bonds between the atoms of the molecules are consequently rearranged. It should be understood that all tautomeric forms, insofar as they may exist, are included within the disclosure. Further, a given chemical formula or name shall encompass all conformers, rotamers, or conformational isomers thereof where such isomers exist. Different conformations can have different energies, can usually interconvert, and are very rarely isolatable. There are some molecules that can be isolated in several conformations. For example, atropisomers are isomers resulting from hindered rotation about single bonds where the steric strain barrier to rotation is high enough to allow for the isolation of the conformers. It should be understood that all conformers, rotamers, or conformational isomer forms, insofar as they may exist, are included within the present disclosure.

As used herein “metal-organic frameworks” or MOFs are compounds having a lattice structure made from (i) a cluster of metal ions as vertices (“cornerstones”) (“secondary building units” or SBUs) which are metal-based inorganic groups, for example metal oxides and/or hydroxides, linked together by (ii) organic linkers. The linkers are usually at least bidentate ligands which coordinate to the metal-based inorganic groups via functional groups such as carboxylates and/or amines. MOFs are considered coordination polymers made up of (i) the metal ion clusters and (ii) linker building blocks.

Aspects of the invention provide an europium doped metal-organic framework for detecting heteroaromatic compounds, comprising europium, and Ni-BTC, wherein the europium is doped in the Ni-BTC; wherein the europium doped metal-organic framework has a formula of Ni₃(BTC)₂·12H₂O:x wt. % Eu³⁺; and wherein x is in the range of 1 to 12.

The europium doped metal-organic framework has a surface area of 100 to 700 m²/gm (square meter per gram), preferably 200 to 600 m²/gm, preferably 200 to 500 m²/gm, preferably 250 to 450 m²/g. In certain preferred embodiments, the europium doped metal-organic framework has a surface area of 250, 275, 300, 325, 350, 375, 400 and/or 425 to 450 m²/g.

The europium doped metal-organic framework is in the form of sheets or micro-petals that are clustered around a center point forming round flower-shaped structures. The sheets or micropetals have an average thickness in a range of 1 to 40 μm, preferably 2 to 30 μm, preferably 3 to 20 μm, preferably 5 to 15 μm, and an average length in a range of 1 to 100 μm, preferably 10 to 80 μm, preferably 20 to 70 μm, preferably 30 to 60 μm. The round flower-shaped structures have an average diameter of from 300-1000 μm, preferably 400-800 μm or 500-700 μm, and a length of the sheets or micro-petals is reduced as a distance from the center of the round flower-shaped structure decreases. The round flower-shaped structures have a roughly circular outline when viewed from above. The round flower-shaped structures include clustered sheets or micro-petals extending to a height of about 0.1-1 times of the average diameter of the round flower-shaped structure. Preferably 0.2-0.8, 0.3-0.6 or about 0.5 times of the average diameter of the round flower-shaped structures.

The europium doped metal-organic framework has a weight loss of less than 2 to 20%, preferably 3 to 15%, preferably 5 to 15%, preferably 10% when heated to a temperature of up to 100 to 600° C., preferably 200 to 500° C., preferably 200 to 400° C., preferably 300° C. for at least 10 to 60 minutes, preferably 10 to 50 minutes, preferably 10 to 40 minutes, preferably 10 to 30 minutes, preferably 10 to 20 minutes, preferably 15 minutes.

The europium doped metal-organic framework preferably has a maximum of 1 to 30 wt. %, preferably 1 to 20 wt. %, preferably 3 to 15 wt. %, preferably 5 to 15 wt. %, preferably 10 wt. % europium doping, wherein wt. % is based on the total weight of the europium doped metal-organic framework to retain the connectivity and framework. In certain embodiments, the europium doped metal-organic framework has a maximum of 2, 4, 6, 8 and/or 10 wt % europium doping to retain the connectivity and framework.

The present disclosure includes a method for producing the europium doped metal-organic framework. The method includes mixing a nickel salt, preferably at least one selected from the group consisting of nickel borate, nickel bromide, nickel carbonate, nickel chloride, nickel fluoride, nickel nitrate, nickel oxalate, nickel oxide, nickel acetate, nickel phosphate, preferably nickel nitrate, an europium salt, preferably at least one selected from the group consisting of europium acetate, europium bromide, europium carbonate, europium chloride, europium nitrate, europium oxalate, europium oxide, preferably europium nitrate, and trimesic acid to produce a mixture; heating the mixture at 100 to 300° C., preferably 100 to 250° C., preferably 100 to 200° C., preferably 120 to 160° C. for 10 to 50 hours, preferably 10 to 40 hours, preferably 15 to 35 hours, preferably 18 to 30 hours, preferably from 18, 20, 22, 24, 26 hours to 28 to 30 hours to produce a heated mixture; and cooling the heated mixture to form the europium doped metal-organic framework.

The present disclosure includes an analytical method for detecting an analyte including: mixing the europium doped metal-organic framework in an aqueous alcohol composition comprising an analyte to form a mixture; wherein the analyte is at least one selected from a group comprising of S-heterocycle, N-heterocycle, and O-heterocycle; and measuring a change in a fluorescence spectrum of the mixture. The analytical method preferably includes measuring a change in a fluorescence spectrum such as an absorption and emission of the mixture.

Eu@Ni(BTC) absorbs in the UV-Vis region with one or more absorption peaks appearing in the spectrum in a range of 300 to 350 nm, preferably at least one single peak appears at 326 nm ±5 nm, preferably ±2 nm or ±1 nm, for the π→π* transition of the organic linkers, and one or more absorption peaks appear in the UV-Vis spectrum in a range of 380 to 420 nm, preferably at least one single peak appears at 403 nm ±5 nm, preferably ±2 nm or ±1 nm due to the ligand-to-metal charge transfer (LMCT) from the oxygen of the carboxylate to the metal centers. In addition, of different heteroaromatic compounds, only thiophene and pyrrole causes the peak at 403 nm to shift to 385 nm ±5 nm, preferably ±2 nm or ±1 nm due to their interaction with the metal centers. The difference in the UV-Vis spectrum caused by complexation of an analyte molecule includes a peak shift of a peak appearing in the UV-Vis spectrum of the Eu@Ni(BTC) in the range 300 to 350 nm to a range of 380 to 420 nm, e.g., a peak shift of from 5-50 nm, preferably 10-40 nm, 20-30 nm or about 25 nm.

The aqueous alcohol composition may contain 0.5 to 20%, preferably 1 to 15%, preferably 1 to 10% of alcohol in water, preferably the aqueous alcohol composition contains 1, 2, 3, 4, 5, 6, 7, 8, and/or 9 to 10% of the alcohol in the water.

The S-heterocycle is at least one selected from a group comprising of a thiophene, a benzothiophene, a dibenzothiophene, and a dibenzothiophene sulfone. Preferably the analyte is thiophene or an alkylated thiophene and the analytical method has a detection limit of 0.05 to 1.0 ppm, preferably 0.07 to 0.8 ppm, preferably 0.1 to 0.5 ppm, more preferably of 0.1, 0.2, 0.3 and/or 0.4 to 0.5 ppm.

The N-heterocycle is at least one selected from a group comprising of a pyrrole, 1-methyl-pyrrole, an indole, a carbazole, pyridine, 2-methyl-pyridine, a quinoline, 2-methyl-quinoline, 2-hydroxy quinoline, and acridine. Preferably the analyte is pyrrole or an alkylated pyrrole and the analytical method has a detection limit of 1 to 20 ppm, preferably 2 to 19 ppm, preferably 3 to 18 ppm, preferably 4 to 15 ppm, more preferably 4, 5, 6, 7, 8, 9, 10, 11, 12, 13 and/or 14 to 15 ppm.

The 0-heterocycle is at least one selected from a group comprising of a dibenzofuran, an alkylated dibenzofuran, and a furan. Preferably the analyte is dibenzofuran and the analytical method has a detection limit of 1 to 20 ppm, preferably 2 to 19 ppm, preferably 3 to 18 ppm, preferably 4 to 15 ppm, more preferably 4, 5, 6, 7, 8, 9, 10, 11, 12, 13 and/or 14 to 15 ppm.

The analytical method may further comprise adding a polar solvent to the mixture, sonicating, and filtering the mixture to separate recovered europium doped metal-organic framework; and washing the recovered europium doped metal-organic framework with an ethanol solvent and drying at a temperature of 50-200° C., preferably 60-180° C., preferably 70-160° C., preferably 80-130° C. for at least 30 minutes to 8 hours, preferably 1 to 5 hours, preferably 2 hours to separate recycled europium doped metal-organic framework.

The europium doped metal-organic framework maintains detection activity when used in the analytical method after it is recycled up to 1 to 20 times, preferably 2 to 16 times, preferably 3 to 14 times, preferably 6 to 10 times, preferably 9 times, more preferably 2, 3, 4, 5, 6, 7, 8 and/or 9 times.

### EXAMPLES

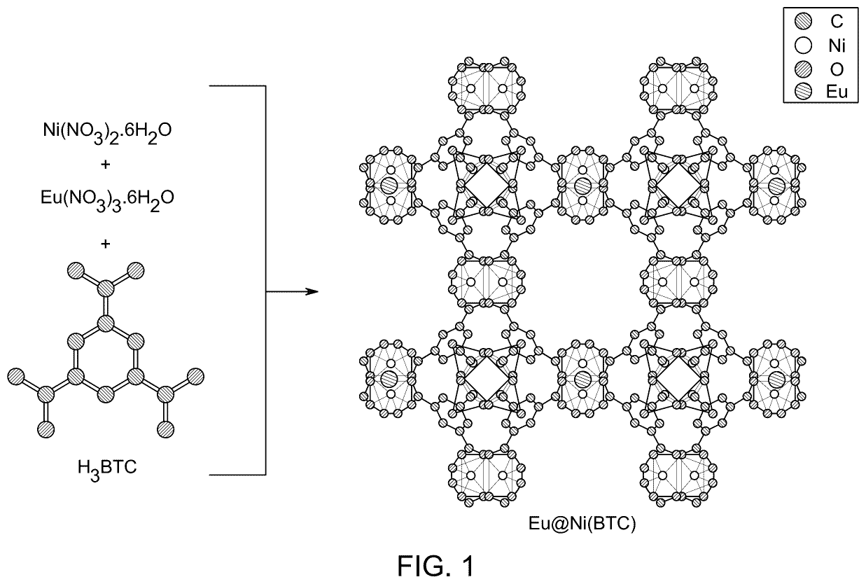

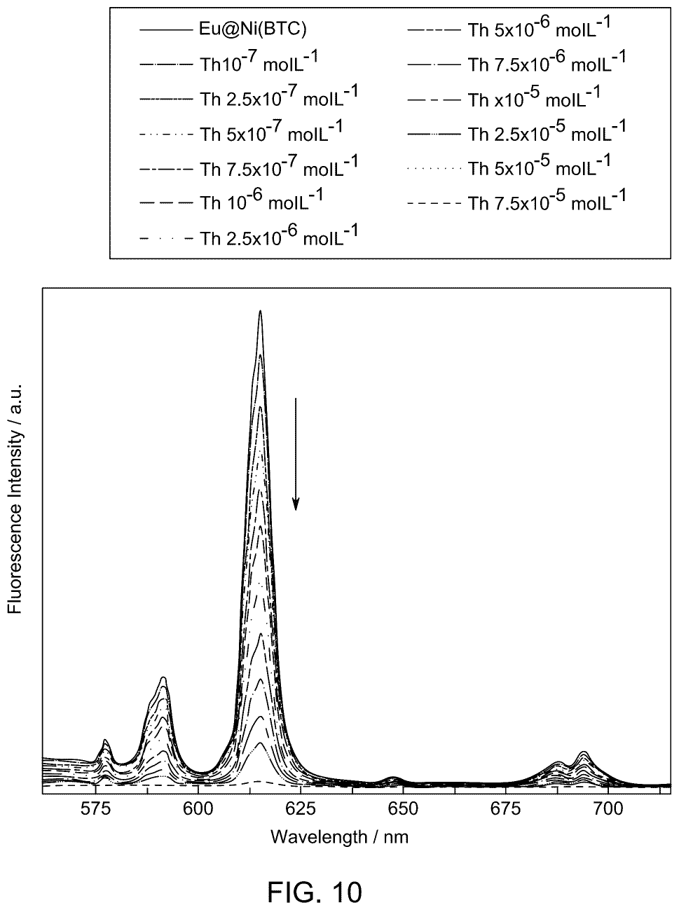

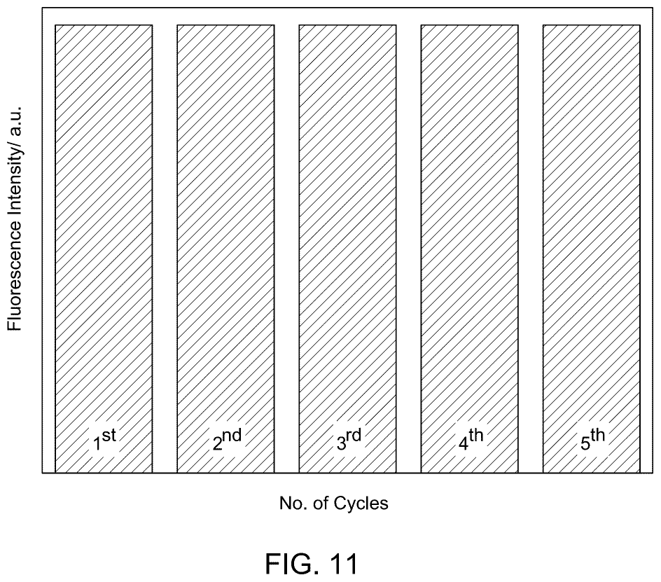

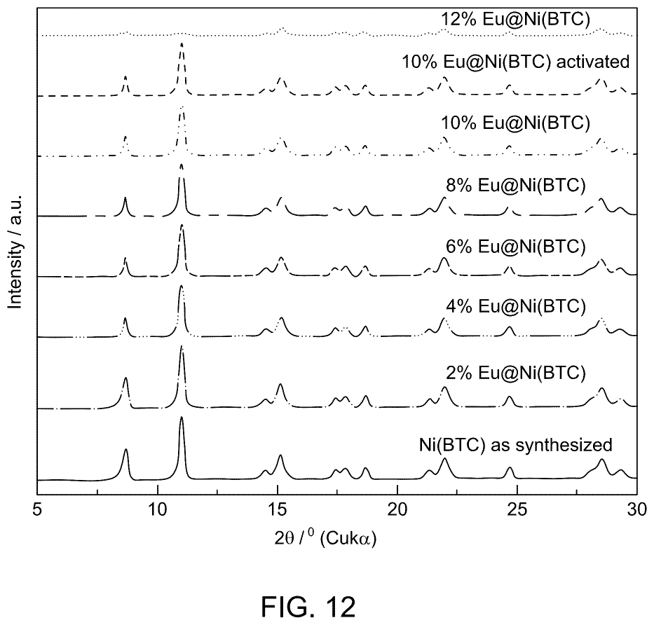

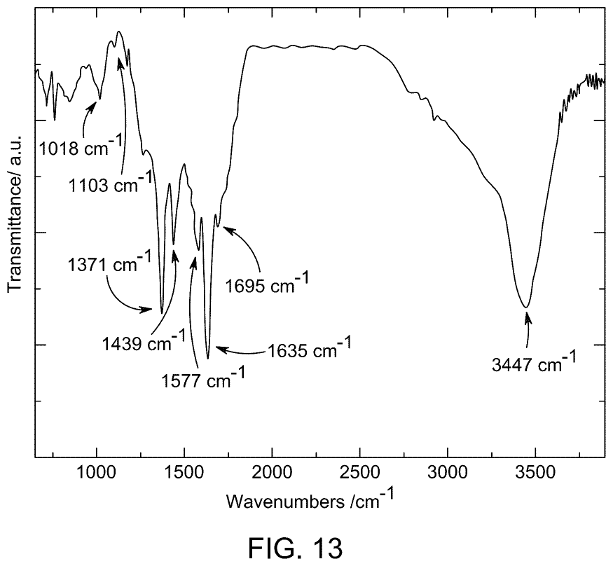

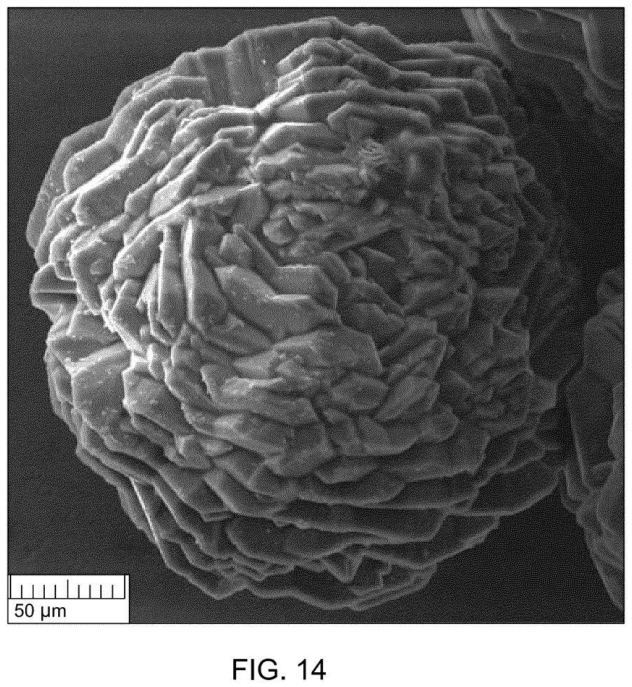

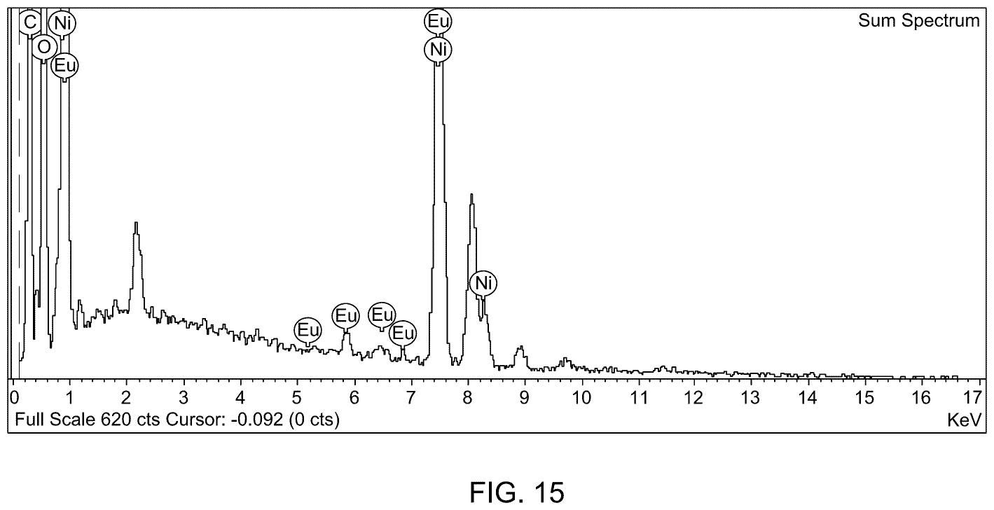

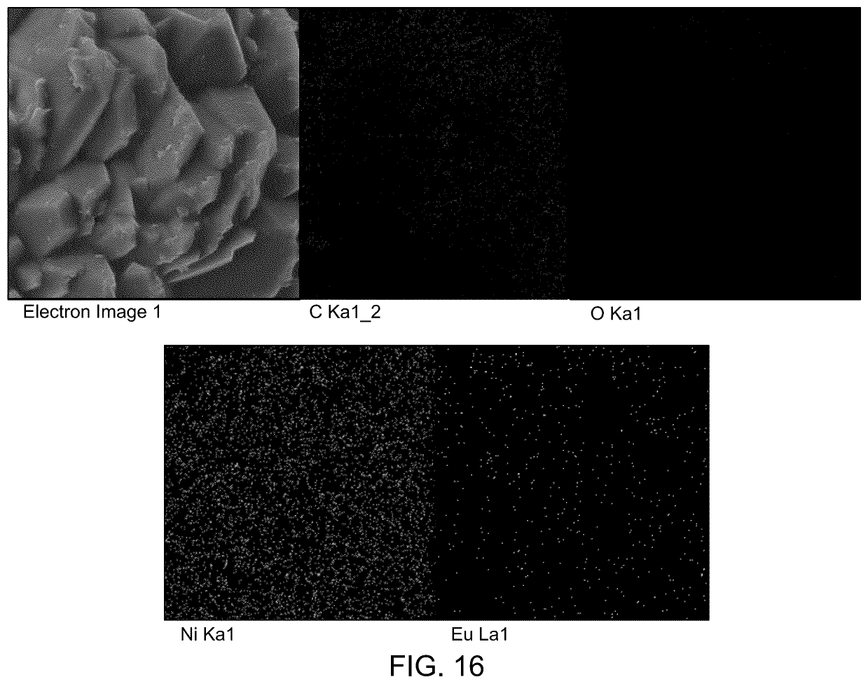

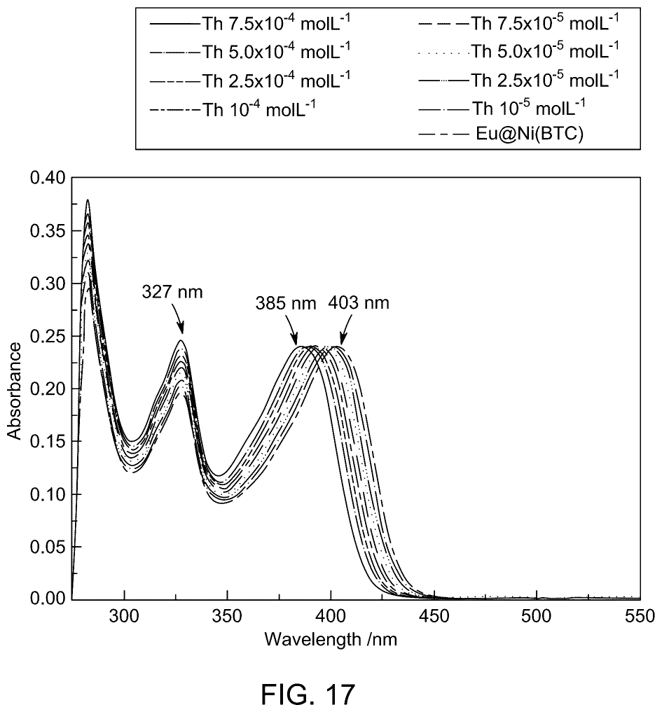

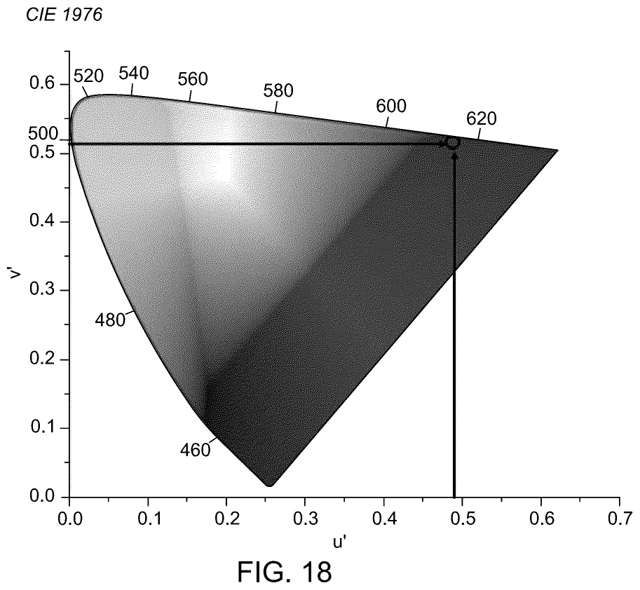

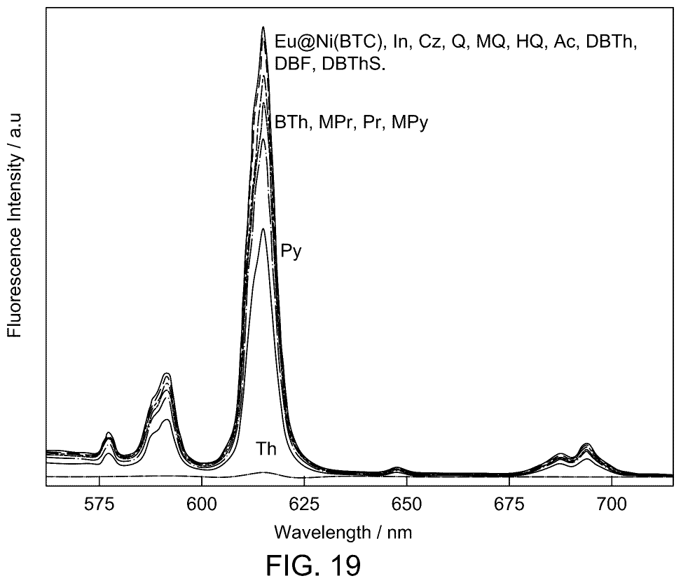

The Ni(BTC) was prepared by a modification of the method reported by Yaghi et al. in Yaghi, O. M.; Li, H.; Groy, T. L. J. Am. Chem. Soc. 1996, 118, 9096-9101. The structural characterization of compound Ni₃(BTC)₂·12H₂O:x % Eu³⁺(x=2, 4, 6, 8, 10, and 12) was done using PXRD as shown in FIG. 11. The PXRD of all the x % Eu@Ni(BTC) samples with different amount of europium doping (x=2, 4, 6, 8, and 10%) indicated the consistency in crystallinity and phase purity with the as synthesized Ni(BTC) MOF (FIGS. 1 and 11). Furthermore, 12% doping with europium destroyed the crystallinity of the Ni(BTC). Without binding to any specific hypothesis, this indicated that maximum 10% doping of Ni(BTC) with europium retained the connectivity and framework (FIG. 1). The 10% Eu@Ni(BTC) abridged as Eu@Ni(BTC) was characterized, and its sensing properties with heteroaromatic compounds were investigated.

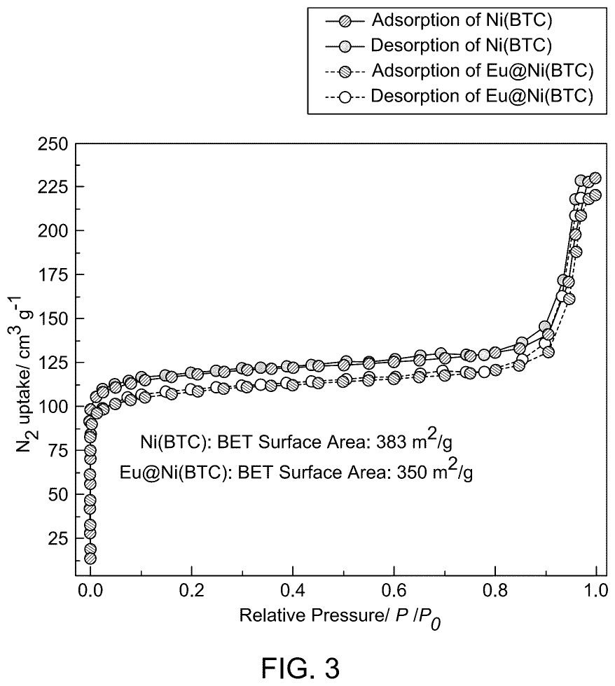

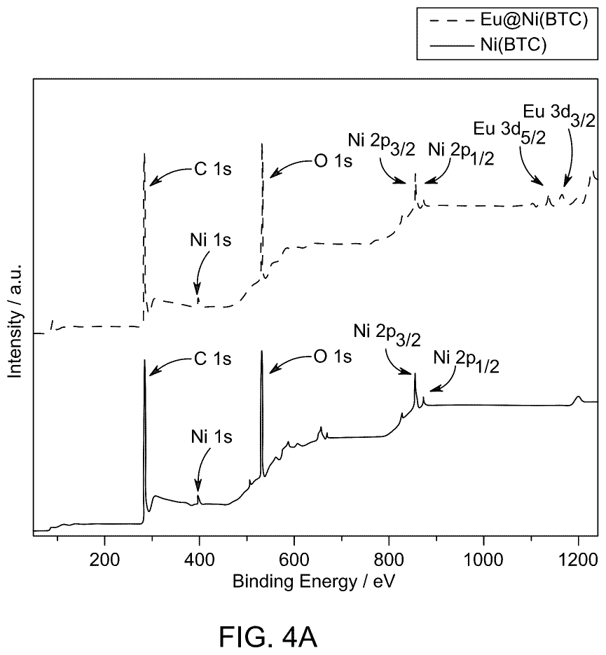

The N₂ adsorption isotherms at 77° K indicated that both Ni(BTC) and Eu@Ni(BTC) were microporous in nature with Type 1 isotherm and their Brunauer-Emmett-Teller surface areas were 383 m²/g and 350 m²/g respectively (FIG. 3). In the XPS (FIG. 4A) data of Ni(BTC) and Eu@Ni(BTC), both the spectra showed peaks at 856.1 eV and 873.3 eV which were ascribed to Ni 2p^{3/2} and 2p^{1/2}, signifying that nickel mainly exists as Ni²⁺. Also, there was a peak at 397.2 eV that corresponds to Ni 1 s. In both spectra, the characteristic peak for C and O occurred at 284.1 eV (Cis) and 531.9 eV (O1 s), respectively. Besides these peaks, europium peaks appeared in Eu@Ni(BTC) at 1137.1 and 1165.3 eV. FIG. 4B represents the high-precision scanning image of Eu3d^{5/2} and Eu3d^{3/2}.

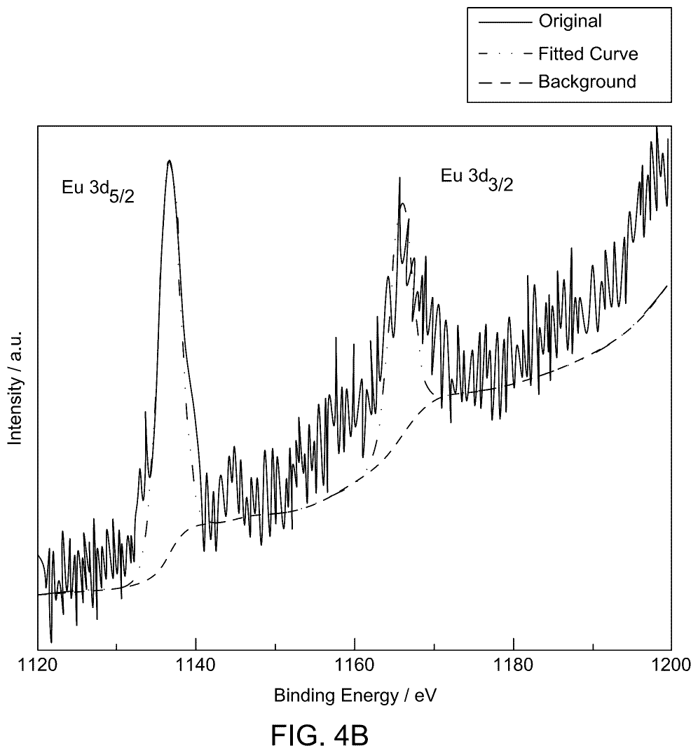

Thermal stability of Eu@Ni(BTC) was studied with the help of thermogravimetric analysis which showed three phases of weight loss. In the first stage (a), there was a loss of 3% at about 150° C. due to the loss of water and solvent molecules from the framework's pores. In the second stage (b), there was a continuous loss of 6.3% from 150-308° C. which was attributed to the loss of coordinated water molecules. The third stage (c) showed a precipitous weight loss of about 51.4% at 308-400° C., associated with the thermal decomposition of the whole framework. The final residue of 39.3% corresponded to the nickel and europium oxides (FIG. 5). The Inductively coupled plasma mass spectroscopy (ICP) mass of Eu@Ni(BTC) indicated that 9.741 mg of europium was recovered per 90 mg nickel which also confirmed the presence of 10% doped europium.

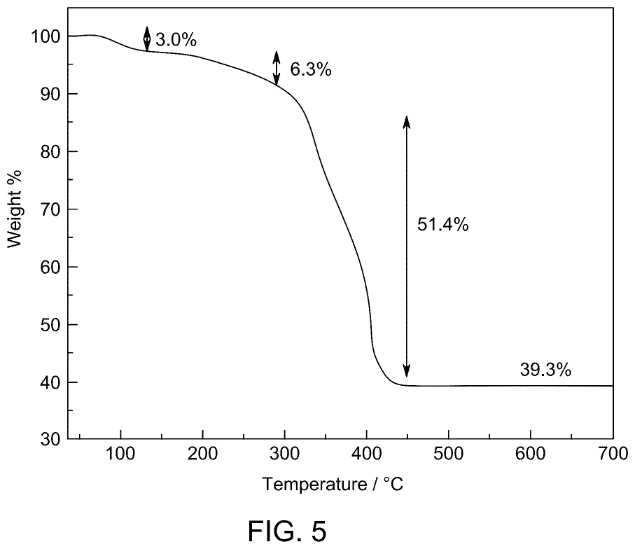

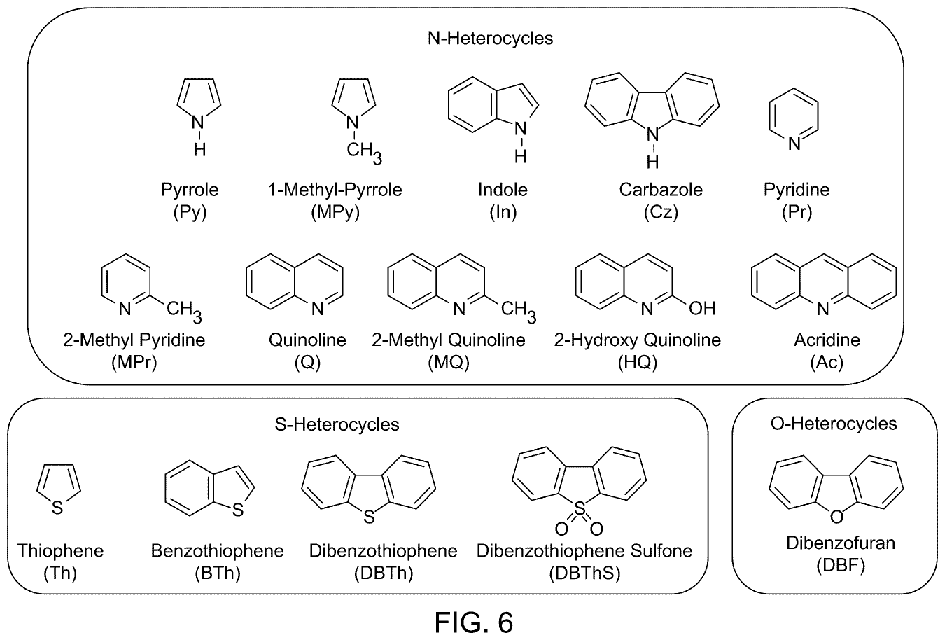

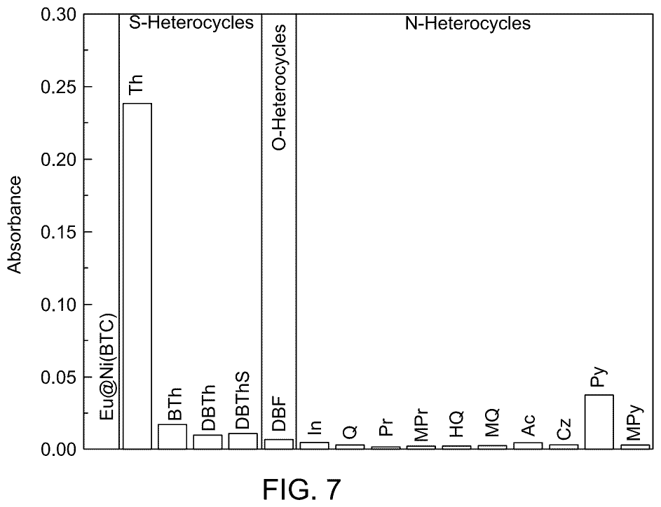

Eu@Ni(BTC) was tested for the optical sensing of different heteroaromatic compounds such as S-Heterocycles, N-Heterocycles, and O-Heterocycles (FIG. 6). All absorption and emission analyses were done in 5% aqueous ethanol (5% ethanol+95% water) with 10⁻² M concentration of the analytes. Eu@Ni(BTC) was found to absorb in the UV-Vis region with absorption peaks at 326 nm, for the π→π* transition of the organic linkers, and at 403 nm due to the ligand-to-metal charge transfer (LMCT) from the oxygen of the carboxylate to the metal centers. In addition, from different heteroaromatic compounds, only thiophene and pyrrole caused the peak at 403 nm to shift to 385 nm due to their interaction with the metal centers (FIG. 7). On excitation of Eu@Ni(BTC) at 327 nm, energy transfer occurred between the excited states of the d-L (nickel-ligand) moiety of the MOF and the ground state of the doped europium. Without binding to any specific theory or hypothesis, this showed that the 3d-metal nickel and its linker BTC acted as the antenna chromophores for the sensitization of the Eu⁺³ resulting in the fluorescence emission spectrum from f-f transition. Characteristic emission peaks were detected at 577, 591, 615, 647, and 694 nm, which complemented to the ⁵D₀→⁷F₀, ⁵D₀→⁷ F₂, ⁵D₀→⁷F₂, ⁵D₀→⁷F₃, and ⁵D₀→⁷F₄ transitions, respectively (FIG. 8). The most profound peak was the ⁵D₀→⁷F₂ transition originating from an Eu^{3 +}with anti-inversion symmetry (FIG. 8).

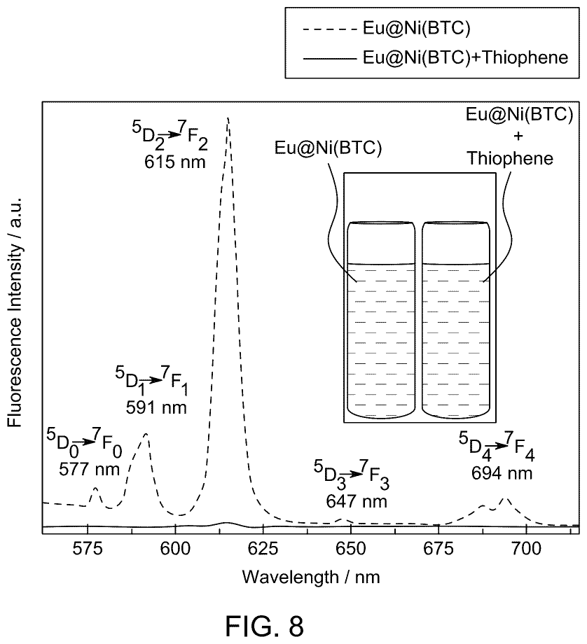

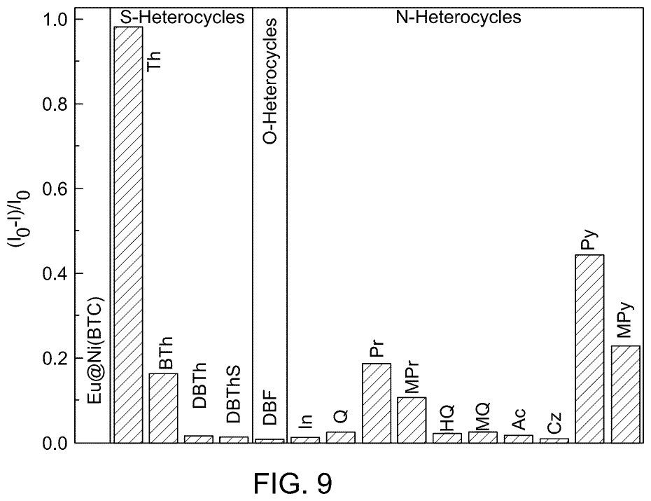

The selectivity of Eu@Ni(BTC) towards various heteroaromatic contaminants was tested by its immersion in a solution of different heteroaromatic compounds, and measurement of its emission properties. As shown in FIG. 9, the emission property at 615 nm of Eu@Ni(BTC) remained consistent with all the heteroaromatic compounds except in the case of thiophene, where the emission property was completely quenched, and in the case of pyrrole, where there was partial quenching.

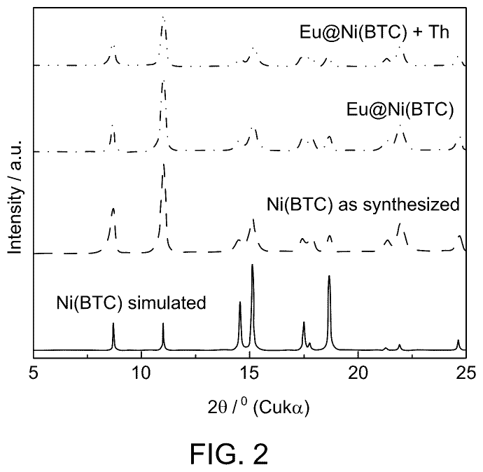

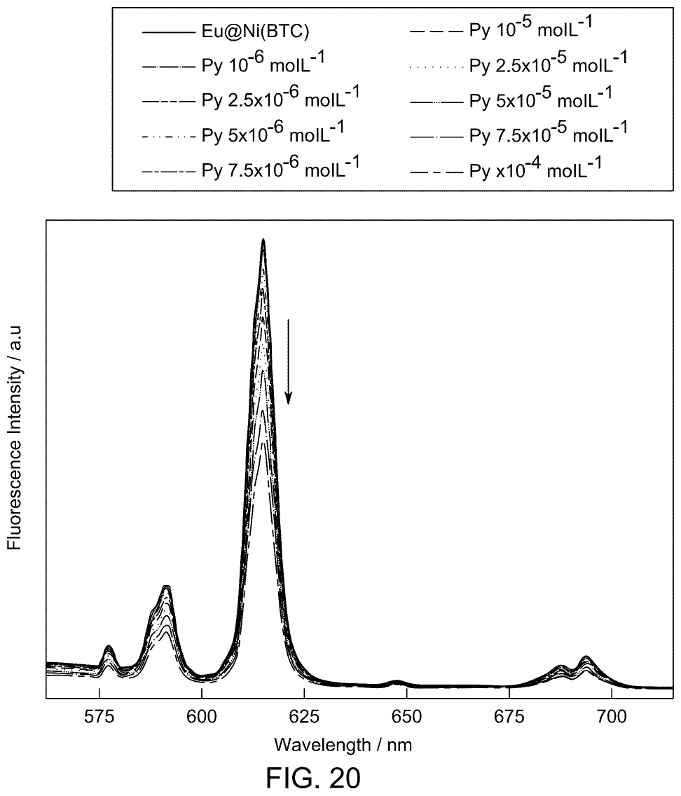

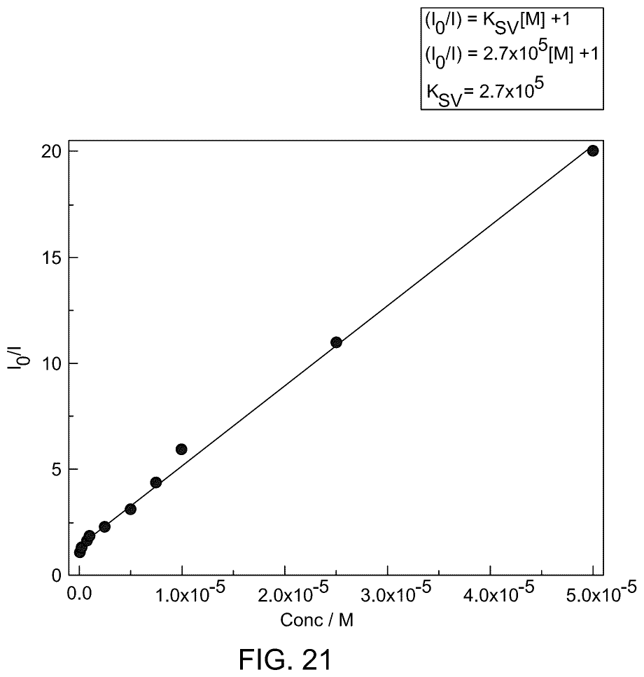

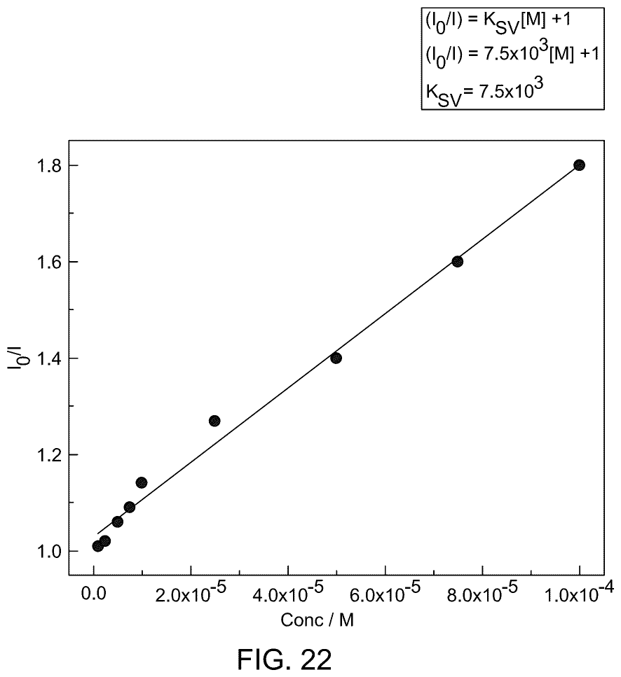

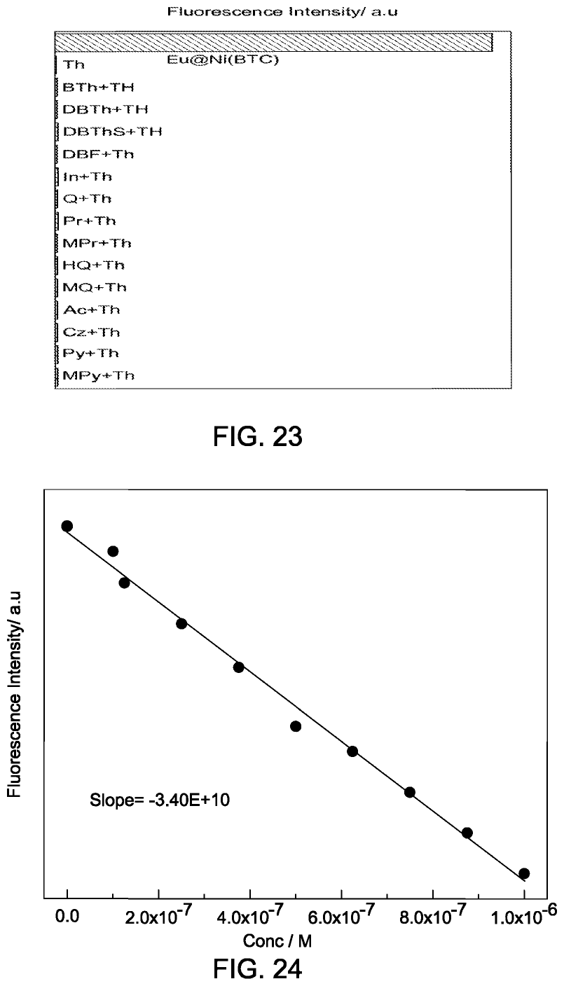

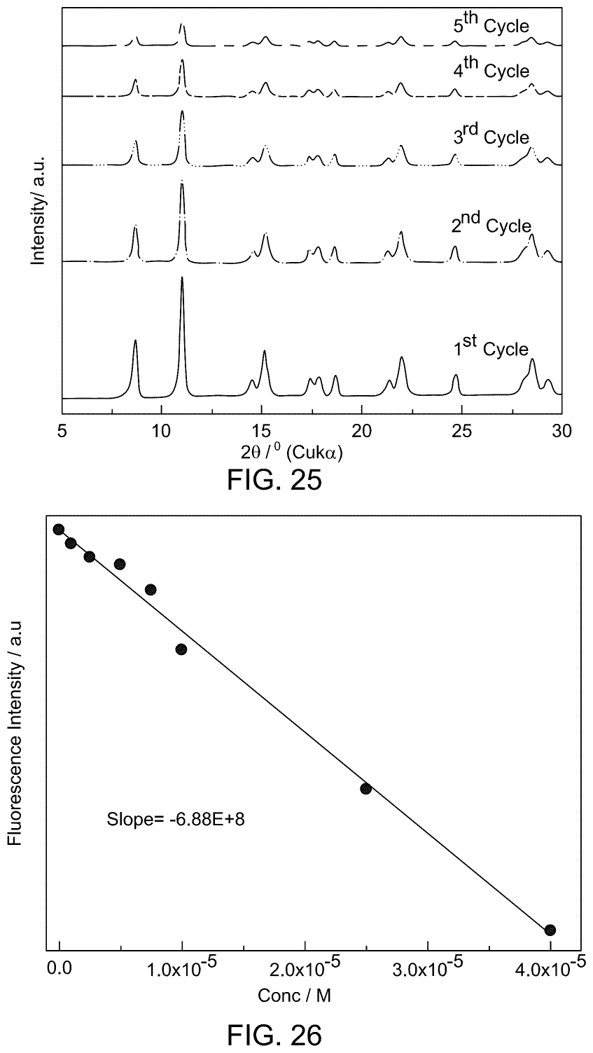

In order to interpret the sensitivity of Eu@Ni(BTC)'s chemosensing properties, alteration in the fluorescent emission intensity was studied as a function of increasing thiophene concentration. The increasing concentration of thiophene quantitatively quenched the fluorescence of Eu@Ni(BTC), and an absolute quenching indicated that a complete complexation was accomplished between the thiophene and the nickel SBU of the Eu@Ni(BTC) (FIG. 8). Photophysical properties of lanthanide ion (Eu³⁺) in Eu@Ni(BTC) largely depended on its coordination environment that includes the ligand (BTC) and the d-block metal ions (Ni²⁺). The coordination of thiophene with the nickel SBU of the Eu@Ni(BTC) caused inhibition of the energy transfer (antenna effect) between the d-L (nickel-BTC) moiety of the MOF and the ground state of the doped Eu⁺³, resulting in the complete quenching of the emission. The quenching efficiency for thiophene and pyrrole was then elucidated by calculating the Stern-Volmer constant. From the titration curve in FIG. 8, the Stern-Volmer constant, Kₛᵥ, was determined to be 2.7×10⁵ for thiophene (FIGS. 21) and 7.5×10³ for pyrrole (FIG. 22), respectively. Furthermore, the sensitivity of Eu@Ni(BTC) towards the detection of thiophene and pyrrole was validated by calculation of the detection limits, which were 0.2 ppm (2.5 μM) and 8.4 ppm (124.7 μM) respectively. Moreover, the addition of thiophene did not alter the crystallinity of Eu@Ni(BTC) (FIG. 2). Competitive binding experiments with Eu@Ni(BTC) were carried out with various heteroaromatic compounds to delve into the feasibility of using it as a practical fluorescent chemosensor. In these experiments, Eu@Ni(BTC) was treated with 200 μL of different competing heteroaromatic compounds (10⁻² M) along with 200 μL of thiophene. The emission spectrum did not show any interference in the fluorescence emission when the competing heteroaromatic compounds were present with thiophene (FIG. 23).

The reusability of Eu@Ni(BTC) as a realistic chemosensor was also illustrated. Dispersion of MOF after the sensing experiment was sonicated for 20 min in N,N-dimethylformamide (DMF, 10 mL) and then washed with ethanol (3×5 mL) followed by vacuum drying at 100° C. for 1 h. Fluorescence spectroscopy, of the recovered MOF, was then performed, and all the emission peaks with the maximum at 615 nm were restored, which was consistent over the course of five consecutive cycles (FIG. 11). Furthermore without binding to any specific theory or hypothesis, the diffraction pattern of the recovered Eu@Ni(BTC) from each cycle signified that the framework's crystallinity was maintained with slight decrease in the intensity and broadening of the peaks due to the agglomeration of the particles of Eu@Ni(BTC) on repeated use.

Eu@Ni(BTC) was also used to detect thiophene in tap water, drinking water, and groundwater. Table 1 shows recovery yield ranging from 96%-101% of thiophene.

TABLE 1
Determination of thiophene in water samples

| | Thiophene spiked | Thiophene detected | |
|---|---|---|---|
| Sample | (μM) | (μM) | Recovery (%) |
| Tap Water | 10 | 10.11 | 101.1 |
| Tap Water | 15 | 14.73 | 98.2 |
| Drinking Water | 10 | 10.09 | 100.9 |
| Drinking Water | 15 | 14.69 | 97.93 |
| Groundwater | 10 | 9.67 | 96.7 |
| Groundwater | 15 | 14.43 | 96.2 |

### Materials and General Methods

Trimesic acid (95%), Nickel nitrate hexahydrate (99.9% purity), Europium nitrate hexahydrate (99.9% purity), N,N-dimethylformamide (DMF; 99.8% purity), ethanol (99.9% purity), dichloromethane (99.8% extra dry grade), all other heteroaromatic compounds used as analytes were purchased from Sigma Aldrich Corporation. All chemicals were used without further purification. Water used in this work was double distilled and filtered through a Millipore membrane. Solutions of metal ions were prepared from their nitrate and chloride salts and anions were prepared from their sodium and potassium salts (analytical grade) followed by subsequent dilution to prepare the working solutions.

### Instrumentation

Powdered X-ray diffraction (PXRD) patterns of the samples were recorded using a Rigaku MiniFlex diffractometer, which was equipped with Cu-Kα radiation. The data were acquired over the 2θ range of 5° and 30° . The FT-IR spectra of Eu@Ni(BTC) were obtained using a Nicolet 6700 Thermo Scientific instrument in the range of 400-4000 cm⁻¹ , using KBr. Thermogravimetric analysis (TGA) of the samples were performed using a TA Q500. In this study, an activated sample of Eu@Ni(BTC) (10 mg) was heated in alumina pan under airflow (60 mL min⁻¹) with a gradient of 10° C. min⁻¹ in the temperature range of 30-800° C. The N₂ adsorption isotherm, for the Brunauer-Emmett-Teller (BET) surface area of the MOFs were calculated by using Micromeritics ASAP 2020 instrument. The surface morphology of these materials was discerned using a field emission scanning electron microscope (FESEM, LYRA 3 Dual Beam, Tescan), which operated at 30 kV. The FESEM samples were prepared from suspension in ethanol. Inductively Coupled Plasma Mass Spectrometry (ICP-MS) of the Nickel and Europium treated samples of Eu@Ni(BTC) were carried in Thermo Scientific XSeries 2 ICP-MS. The absorption spectra of the MOF were studied using a Jasco V-670 spectrophotometer. Fluorescence spectra were measured using a Horiba, Fluorolog-3 fluorescence spectrophotometer, which was equipped with a xenon discharge lamp and 1 cm quartz cells with slit width of 2 nm for both the source and the detector. The quantum yield and chromaticity studies were done using Fluoromax-4 equipped with Quanta-Phi integration sphere (Horiba) by using liquid sample holder at room temperature.

Synthesis of Ni₃(BTC)₂·12H₂O [Ni(BTC)]

A mixture of nickel(II) nitrate hexahyderate (1.65 mmol) and the trimesic acid (0.95 mmol) in water (15 mL) was placed in a stainless steel autoclave, which was sealed and placed in an oven at 140° C. for 24 h. The mixture was then cooled to room temperature. The resulting microcrystalline solids were filtered, washed with deionized water (3×10 mL) and ethanol (3×10 mL), and then dried in a vacuum oven at 120° C. for 24 h to get Ni(BTC).

Synthesis of Ni₃(BTC)₂·12H₂O:x % Eu³⁺ (x=2, 4, 6, 8, 10, and 12) [Eu@Ni(BTC)]

A mixture of nickel(II) nitrate hexahydrate (1.0-y mmol), Europium nitrate hexahydrate (y=0.02, 0.04, 0.06, 0.08, 0.10, and 0.12 mmol) and trimesic acid (0.58 mmol) were placed in a stainless steel autoclave, which was sealed and placed in an oven at 140° C. for 24 h. The mixture was then cooled to room temperature. The resulting microcrystalline solids were filtered, washed with deionized water (3×10 mL) and ethanol (3×10 mL), and then dried in a vacuum oven at 120° C. for 24 h to get different amount of doped Eu@Ni(BTC).

### Sample Preparation for Photophysical Studies

In a typical luminescence-sensing experimental setup, 1 mg of Eu@Ni(BTC) powder was dispersed in 1 ml of 5% ethanol water solution to make the stock solution of the sensor. In a 1 cm quartz cuvette, 3 mL of dispersed aqueous solution of Eu@Ni(BTC) was placed and the absorption and emission responses were measured in-situ after incremental addition of freshly prepared analyte solutions. The dispersion of Eu@Ni(BTC) with the analytes were stirred on a magnetic stirrer for 5 minutes after each incremental addition of the analytes for uniform dispersion during the luminescent measurements. All measurements were performed at 298° K.

### Practical Application in Water Samples

Eu@Ni(BTC) was used for the detection of thiophene in tap water, drinking water, and ground water by standard addition method. The thiophene concentration in these water without spiked thiophene was not detectable by the sensor. All water samples were filtered three times through a 0.2 mm membrane filter. Then these three water samples were mixed with ethanol to make a mixed aqueous solution (5% ethanol +95% water). Then six samples spiked with two different concentrations (10 and 15 μM) of thiophene, and were titrated against the Eu@Ni(BTC). Each measurement was repeated three times and the mean was taken as given in Table 2.

TABLE 2
Detection Limit Calculation

| | | |
|---|---|---|
| Blank Readings | Thiophene | Pyrrole |

| | | |
|---|---|---|
| 1 | Fluorescence Intensity | 9606860 |
| 2 | Fluorescence Intensity | 9636780 |
| 3 | Fluorescence Intensity | 9607560 |
| 4 | Fluorescence Intensity | 9627680 |
| 5 | Fluorescence Intensity | 9646860 |
| 6 | Fluorescence Intensity | 9566862 |

| | |
|---|---|
| Standard Deviation (δ) | 28593.57 |

| Slope (σ) | 3.4 × 10¹⁰ μM | 6.88 × 10⁸ μM |
|---|---|---|
| Detection limit (3δ/σ) | 2.5 μM/ | 124.7 μM/ |
| | 0.2 ppm | 8.4 ppm |

### Emission Properties of Eu@Ni(BTC)

The emission spectra were corrected for the inner filter effect by using the following correction factor:

F_{corr}=F₀×10^{(A}^{ₑₓ}^{l}^{ₑₓ}^{+A}^{ₑₘ}^{l}^{ₑₘ}⁾

where F_{corr} is the corrected fluorescence intensity, Aₑₓ is the absorbance at the excitation wavelength, lₑₓ is the penetration depth of the light into the sample, Aₑₘ is the absorbance over the emission wavelength and lₑₘ is the emission path length.

### The Calculation Method for the Binding Constant

The quenching effect of Eu@Ni(BTC) was examined as a function of thiophene/pyrrole concentration. The Eu@Ni(BTC) was titrated with the analytes and then their luminescence intensity at 615 nm was recorded. As shown in FIGS. 21 and 22, the fluorescence intensity vs [thiophene/pyrrole] plot can be curve-fitted into (I₀/I)−1=K_{SV}[thiophene/pyrrole], the Stern-Volmer equation:

(I₀/I)−1=K_{SV}[M]

where I₀ and I are the luminescent intensity before and after metal ion incorporation, respectively; [M] is the thiophene/pyrrole molar concentration; and K_{SV} is the Stern-Volmer constant or the binding constant of thiophene/pyrrole with Eu@Ni(BTC).

### Determination of the Detection Limit

The detection limit was calculated based on the fluorescence quenching titration experiments. To determine the signal-to-noise (S/N) ratio, the fluorescence emission spectrum of Eu@Ni(BTC) without thiophene or pyrrole was measured six times and the standard deviation of the blank measurements was determined. To gain the slope of the linear range of the analytes, the fluorescence intensity at 615 nm was plotted as a concentration of the analytes.

The detection limit was calculated with the following equation:

Detection limit=3δ/σ

Where δ is the standard deviation of blank measurement, σ is the slope between the normalized fluorescence intensity versus analyte concentration.

Numerous modifications and variations of the present invention are possible in light of the above teachings. It is therefore to be understood that within the scope of the appended claims, the invention may be practiced otherwise than as specifically described herein.

1: An europium doped metal-organic framework comprising:
europium, and
Ni-BTC,
wherein the europium is doped in the Ni-BTC;
wherein the europium doped metal-organic framework has a formula of Ni₃(BTC)₂·12H₂O:x wt % Eu³⁺; and
wherein x is in the range of 1 to 12;
wherein x wt % is based on the total weight of the europium doped metal-organic framework.

2: The europium doped metal-organic framework of claim 1, having a surface area of 250 to 450 square meter per gram (m²/g).

3: The europium doped metal-organic framework of claim 1, comprising a plurality of micro-petals having an average thickness in a range of 1 to 40 μm, and an average length in a range of 1 to 100 μm wherein the plurality of micro-petals is clustered into round flower-shaped structures with an average diameter of 300-1000 μm.

4: The europium doped metal-organic framework of claim 1, having a weight loss of less than 10% when heated to a temperature of up to 300° C. for at least 15 minutes.

5: The europium doped metal-organic framework of claim 1, comprising no more than 10 wt. % of europium, wherein wt. % is based on the total weight of the europium doped metal-organic framework.

6: A method for producing the europium doped metal-organic framework of claim 1, comprising:
mixing a nickel salt, an europium salt, and trimesic acid to produce a mixture;
heating the mixture at 120 to 160° C. for 18 to 30 hours to form the europium doped metal-organic framework.

7: A method for detecting heteroaromatic compounds with the europium doped metal-organic framework of claim 1, the method comprising:
mixing the europium doped metal-organic framework with an aqueous alcohol composition comprising an analyte to form a mixture;
wherein the analyte is at least one selected from a group comprising of an S-heterocycle, an N-heterocycle, and an O-heterocycle; and
measuring a change in a fluorescence spectrum of the mixture.

8: The method of claim 7, wherein the aqueous alcohol composition comprises 1 to 10% of alcohol in water.

9: The method of claim 7, wherein the concentration of the analyte in the aqueous alcohol composition is 10⁻¹-10⁻³ M.

10: The method of claim 7, wherein the analyte is at least one S-heterocycle selected from a group consisting of thiophene, benzothiophene, dibenzothiophene, and dibenzothiophene sulfone.

11: The method of claim 7, wherein the analyte is at least one N-heterocycle selected from a group consisting of pyrrole, 1-methyl-pyrrole, indole, carbazole, pyridine, 2-methyl-pyridine, quinoline, 2-methyl-quinoline, 2-hydroxy quinoline, and acridine.

12: The method of claim 7, wherein the analyte is at least one O-heterocycle selected from a group consisting of dibenzofuran, alkylated dibenzofuran, and furan.

13: The method of claim 7, wherein the analyte is thiophene or an alkylated thiophene present in the aqueous alcohol composition in a concentration of 0.1-0.5 ppm based on the mass of the aqueous alcohol composition.

14: The method of claim 7, wherein the analyte is pyrrole or an alkylated pyrrole present in the aqueous alcohol composition in a concentration of 4-15 ppm based on the mass of the aqueous alcohol composition.

15: The method of claim 7, further comprising:
adding a polar solvent to the mixture, sonicating the mixture, and filtering the mixture to separate a recovered europium doped metal-organic framework; and
washing the recovered europium doped metal-organic framework with ethanol and drying at a temperature of 80-130° C. for at least 2 hours to form a recycled europium doped metal-organic framework.

16: The method of claim 15, wherein the europium doped metal-organic framework maintains detection activity after it is recycled up to 9 times.
